(19) United States
(12) Patent Application Publication
(10) Pub. No.: US 2008/0144563 A1
(43) Pub. Date: Jun. 19, 2008

(54) USE OF TERRESTRIAL CHANNELS TO AUGMENT SATELLITE CHANNELS FOR LOW LATENCY TRAFFIC

(75) Inventor: Steven Hart, Carlsbad, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 11/959,257

(22) Filed: Dec. 18, 2007

Related U.S. Application Data
(60) Provisional application No. 60/870,771, filed on Dec. 19, 2006.

(51) Int. Cl. H04B 7/185

(52) U.S. Cl. 370/316

(57) ABSTRACT

Methods, systems, and devices are described for intelligently routing network data in satellite communication networks based on parametric sensitivities. Some embodiments of the invention provide methods, systems, and devices for routing data based on the latency-sensitivity of the data and multiple networks in a network environment. Some of these embodiments also provide for voice-over-internet-protocol capabilities to provide a network environment which allows for high throughput and low physical latency, without tying up a phone line. Other embodiments of the invention provide methods, systems, and devices for routing data based on the parametric-sensitivity of the data and multiple networks in a network environment.

### CROSS REFERENCES

This application claims priority from co-pending U.S. Provisional Patent Application No. 60/870,771, filed Dec. 19, 2006, entitled “Use of Terrestrial Channels to Augment Satellite Channels for Low Latency Traffic,” which is hereby incorporated by reference as if it were set forth in full in this document, for all purposes.

### BACKGROUND

The present invention relates to satellite communications systems in general and, in particular, to data routing within network environments including satellite communications systems.

In today's communications environment, many different network types are available for sending data to locations around the globe. The various network types differ in bandwidth, protocol support, traffic patterns, reliability, distance vectors, costs per bit, and many others characteristics. These characteristics affect how different data types pass through the different network topologies, creating certain advantages and disadvantages for different applications.

Satellite networks may use geosynchronous satellites for connectivity to the Internet, while dial-up networks provide connectivity over phone lines. One difference between satellite networks and dial-up networks is the ability of satellite networks to provide larger amounts of bandwidth to communication channels, which may benefit applications requiring large amounts of data to be communicated over the network. Another difference between satellite networks and dial-up networks is the ability of satellite networks to provide Internet connectivity without tying up a customer's phone line. Since dial-up networks use the phone lines for connectivity, customers are unable to send and receive phone calls while connected to the Internet.

One disadvantage of satellite networks, however, is the travel delay (or physical latency) caused by the distance information must travel from the ground to the satellite and back. For many applications, this delay is insignificant (especially when mitigated by protocol enhancement methods, like performance enhancing proxies). For other applications, like voice communications and real-time Internet gaming, the delay can be problematic.

Various approaches have attempted to improve network performance. In one example, different protocols are used to manage data as it flows through a network. In a second example, dynamic network switching is used to switch to predetermined networks upon detection of those networks (e.g., a cell phone may maintain access to the Internet through its cellular network, but switch to WiFi upon detection of a WiFi hot spot). In a third example, multiple networks are used in parallel for added capabilities, like with the DirecPC™ system. DirecPC™ provides a one-way satellite connection plus a one-way telephone connection as a “back channel.” An advantage of DirecPC™ is the ability to exploit some of the throughput of the satellite link while using the “back channel” to mitigate physical latency. A disadvantage, however, is that the “back channel” may tie up a phone line, limiting the ability to have a phone conversation while connected to the Internet.

### SUMMARY

Many different types of data flow through many different types of communications networks. Each type of data may have a particular sensitivity to certain parameters (or parametric sensitivities), like bandwidth, bit rate, protocol, delay, sensitivity, etc. For example, voice calls may be highly sensitive to delay, but not as sensitive to bandwidth. Further, each type of communications network may have network characteristics which are either advantageous or disadvantageous to a certain type of data, depending on the parametric sensitivities of that type of data.

Embodiments of the invention intelligently route different data types by selecting network routing paths among networks with different network characteristics, based on the parametric sensitivities of the different data types being routed.

Some embodiments provide a customer premises device (CPD) for routing latency sensitive data in a satellite communications system. The CPD includes an output data channel for receiving output data from an output data source, a voice output channel for receiving output voice-over-internet-protocol (VoIP) data from a VoIP data source, a number of transmission channels, an analyzer, and a router. At least one of the transmission channels is configured for communication with a first data transmission system, and at least another is configured for communication with a second data transmission system. The first data transmission system includes a satellite transmitter, and the second data transmission system has lower physical latency than the first data transmission system. The analyzer is in operative communication with the output data channel and the voice output channel. The analyzer is also configured to determine the latency sensitivity of at least a portion of the output data, and determine the appropriate routing for the output voice-over-internet-protocol data. The router is in operative communication with the analyzer and configured to route the portion of output data to at least one of the communication channels, based at least in part on the determinations of the analyzer.

Certain embodiments also include a first subset of communication channels configured for transmitting output data and a second subset of communication channels configured for receiving input data, which includes input VoIP data. In these embodiments, the CPD may also include a data handler, an input data channel, and an input voice channel. The data handler may be in operative communication with the second subset of communication channels, and configured to parse the input voice-over-internet-protocol data from the input data. The input data channel may be in operative communication with the data handler, and configured to transmit the input data to the output data source. The input voice channel may be in operative communication with the data handler, and configured to transmit the input voice-over-internet-protocol data to the voice-over-internet-protocol data source.

Other embodiments provide a method for routing latency sensitive data in a satellite communications system. The method includes receiving output data from an output data source through an output data channel, receiving output VoIP data from a VoIP data source through a voice output channel, determining the latency sensitivity of at least a portion of the output data using an analyzer in operative communication with the output data channel and the voice output channel, determining the appropriate routing for the output VoIP data using the analyzer, and routing the portion of output data to at least one of a number of communication channels using a router in operative communication with the analyzer. The routing is based at least in part on the determining steps. At least one of the transmission channels is configured for communication with a first data transmission system, and at least another of the transmission channels is configured for communication with a second data transmission system. The first data transmission system includes a satellite transmitter and the second data transmission system has lower physical latency than the first data transmission system.

Certain embodiments also include a first subset of communication channels configured for transmitting output data and a second subset of communication channels configured for receiving input data. The input data includes input VoIP data, and the method further includes parsing the input VoIP data from the input data using a data handler, transmitting the input data to the output data source using an input data channel, and transmitting the input VoIP data to the VoIP data source using an input voice channel. The data handler is in operative communication with the second subset of communication channels, the input data channel is in operative communication with the data handler, and the input voice channel is in operative communication with the data handler.

Still other embodiments provide a CPD for routing parameter sensitive data in a satellite communications system. The CPD includes an output data channel configured to receive output data from an output data source, a number of transmission channels, a data flow analyzer, and a router. At least one of the transmission channels is configured for transmission to a first data transmission system characterized by a first system profile relating to a predefined set of system parameters, and at least another is configured for transmission to a second data transmission system characterized by a second system profile relating to the set of system parameters. The data flow analyzer is in operative communication with the output data channel and configured to determine the parametric sensitivity of at least a portion of the output data. The router is in operative communication with the analyzer and configured to route the portion of output data to at least one of the communication channels, based at least in part on the determination of the analyzer.

In certain embodiments, the CPD also includes a number of reception channels, a data handler, and an input data channel. At least one of the reception channels is configured to receive data from a first data reception system characterized by a third system profile relating to the set of system parameters, and at least another is configured to receive data from a second data reception system characterized by a fourth system profile relating to the set of system parameters. The data handler is in operative communication with the reception channels, and configured to analyze at least a portion of the received data to make a data handling determination, and convert at least a portion of the received data into input data, the input data being compatible with an input data receiver. The input data channel is in operative communication with the data handler and the input data receiver, and configured to transmit at least a portion of the input data to the input data receiver. In certain of these embodiments, the CPD also includes a first data system and a second data system. The first data system includes the first data transmission system and the first data reception system, and the second data system includes the second data transmission system and the second data reception system.

Yet other embodiments provide a gateway device for routing latency sensitive data. The gateway device includes a number of reception channels, a data handler, and an input data channel. At least one of the reception channels is configured to receive data from a first data reception system characterized by a first set of system parameters, and at least another is configured to receive data from a second data reception system characterized by a second set of system parameters. The data handler is in operative communication with the number of reception channels, and configured to analyze at least a portion of the received data to make a data handling determination, and convert at least a portion of the received data into input data, the input data being compatible with an input data receiver. The input data channel is in operative communication with the data handler and the input data receiver, and configured to transmit at least a portion of the input data to the input data receiver.

In certain embodiments, the gateway device also includes a services gateway, an output data channel, a number of transmission channels, a parametric sensitivity analyzer, and a parameter-sensitive router. The services gateway is in operative communication with the input data receiver, and configured to provide output data related at least in part to the input data. The output data channel is in operative communication with the services gateway, and configured to receive at least a portion of the output data from the services gateway. At least one of the transmission channels is configured for transmission to a first data transmission system characterized by a third set of system parameters, and at least another is configured for transmission to a second data transmission system characterized by a fourth set of system parameters. The parametric sensitivity analyzer is in operative communication with the output data channel and configured to determine the parametric sensitivity of at least a portion of the output data. The parameter-sensitive router is in operative communication with the parametric sensitivity analyzer and configured to route the portion of output data to at least one of the transmission channels, based at least in part on the determination of the parametric sensitivity analyzer.

Other embodiments provide a method for routing parameter sensitive data. The method includes receiving output data from a data source using a parametric sensitivity analyzer, determining the parametric sensitivity of at least a portion of the output data using the parametric sensitivity analyzer based at least in part on a set of parametric sensitivity criteria, and routing the portion of output data to a transmission channel based at least in part on the results of the determining step. At least one of the transmission channels is configured for transmission to a first data transmission system characterized by a first set of system parameters, and at least another is configured for transmission to a second data transmission system characterized by a second set of system parameters.

In certain embodiments, the method also includes receiving input data from a number of reception channels, analyzing at least a portion of the received data to make a data handling determination using a data handler in operative communication with the number of reception channels, converting at least a portion of the received data into input data using the data handler, and transmitting at least a portion of the input data to the input data receiver. At least one of the reception channels is configured to receive from a first data receiving system characterized by a third set of system parameters, and at least another is configured to receive from a second data receiving system characterized by a fourth set of system parameters.

### BRIEF DESCRIPTION OF THE DRAWINGS

A further understanding of the nature and advantages of the present invention may be realized by reference to the following drawings:

FIG. 1 provides a block diagram of an embodiment of a parameter-sensitive network environment.

FIG. 2 provides a block diagram of an embodiment of a multi-channel network environment with both a CPD and a gateway routing device.

FIG. 3 provides a block diagram of an embodiment of a parameter-sensitive customer premises device (CPD).

FIG. 4 provides a block diagram of an embodiment of a parameter-sensitive gateway routing device.

FIG. 5 provides a block diagram of an embodiment of a latency-sensitive network environment.

FIG. 6 provides a block diagram of another embodiment of a CPD.

FIG. 7 provides timelines representing data flow within embodiments of the invention.

FIG. 8 provides other timelines representing data flow within embodiments of the invention.

FIG. 9 provides a flow diagram of an embodiment of a method for routing parameter-sensitive data.

FIG. 10 provides another flow diagram of an embodiment of a method for routing parameter-sensitive data.

FIG. 11 provides a flow diagram of an embodiment of a method for routing large upload data.

FIG. 12 provides a flow diagram of an embodiment of a method for routing VoIP data.

FIG. 13 provides a flow diagram of an embodiment of a method for routing online gaming data.

FIG. 14 provides a flow diagram of an embodiment of a method for receiving parameter-sensitive data.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Among other things, systems, devices, methods, and software are described for routing various types of data in satellite communication systems. Some embodiments provide systems and methods for improved routing of data which are sensitive to various parameters, by exploiting varying communication network characteristics. Other embodiments provide systems and methods for improved simultaneous routing of satellite communication data and voice-over-internet-protocol (VoIP) data, by utilizing multiple communication channels with varying physical latency or other characteristics.

### Parameter-Sensitive Data Routing Systems

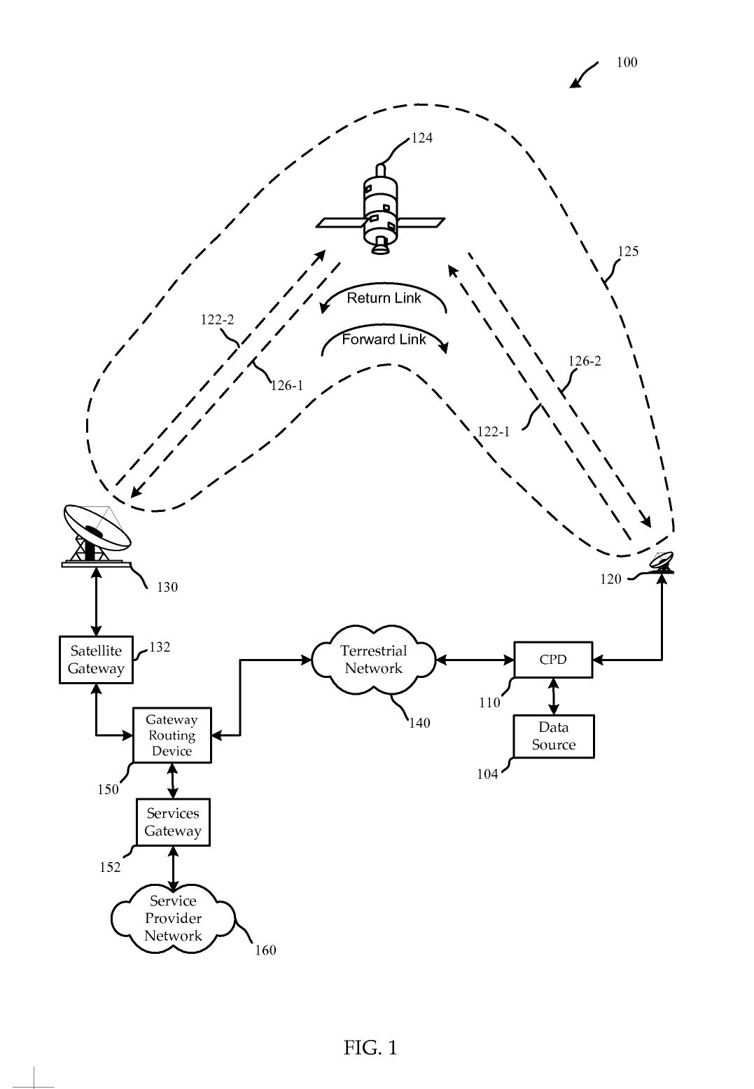

FIG. 1 provides a block diagram of an embodiment of a parameter-sensitive satellite network environment 100. It should be noted that, while many embodiments of the invention are discussed in the context of a satellite network environment, other types of network environment are possible. Further, it will be appreciated that embodiments of the invention may operate within satellite networks augmented with other network connectivity (e.g., hybrid networks with both satellite communication links and terrestrial communication links). As such, phrases like “satellite network” and “satellite communication system” should be broadly construed to encompass satellite networks augmented with other types of network connectivity.

The parameter-sensitive satellite network environment 100 includes a consumer premises device (CPD) 110 and a gateway routing device 150. The CPD 110 includes a router and is configured to receive data from a data source 104. The data source 104 may be any one or more sources of data to be routed over the parameter-sensitive satellite network environment 100, including any type of consumer premises equipment (e.g., a telephone, modem, router, computer, or set-top box).

The data source 104 may generate many different types of data, each with different characteristics. One type of data may require the best efforts of the network for its communication (e.g., login information, e-commerce transaction information, etc.). Another type of data may be rate sensitive, requiring a minimum rate guarantee from the network (e.g., H.323 videoconferencing data, etc.). Still another type data may be delay sensitive, exhibiting a highly variable rate, but requiring timeliness in network delivery (e.g., MPEG-II video data, etc.). Because of these different data characteristics, different types of data have different parametric sensitivities (i.e., the sensitivities to one or more parameters). The parametric sensitivities may involve sensitivities to cost per bit, network congestion, physical latency, packet loss, access rights, routing protocols, predefined or stored algorithms, priority, or any other relevant parameters.

The CPD 110 is further configured to route the data received from the data source 104 to either a satellite network 125 (via a customer satellite transceiver 120) or to a terrestrial network 140. The satellite network 125 includes a forward link for sending information from the gateway routing device 150 to the CPD 110, and a return link for sending information from the CPD 110 to the gateway routing device 150. The forward link includes a transmission path from the gateway routing device 150 through a satellite gateway 132 and its gateway satellite transceiver 130, through a satellite 124 via a satellite uplink channel 122-2, to the customer satellite transceiver 120 via a satellite downlink channel 126-2, and to the CPD 110. The return link includes a transmission path from the customer satellite transceiver 120, to the satellite 124 via the satellite uplink channel 122-1, to the gateway satellite transceiver 130 via the satellite downlink channel 126-1, through the satellite gateway 132, and to the gateway routing device 150. Each transmission channel may utilize multiple satellites and transceivers.

Different networks have network characteristics that are compatible with certain parametric sensitivities of certain data types. The set of network characteristics may include sensitivities to cost per bit, network congestion, physical latency, packet loss, access rights, certain types of routing protocols, predefined or stored algorithms, priority, or any other relevant characteristic. Further, the set of network characteristics may be the same or different from the parametric sensitivities of the different data types. The CPD 110 is configured to route data based on the parametric sensitivities of the data supplied to the CPD 110 and the networks connected to the CPD 110.

A first set of data is routed from the CPD 110 to the gateway routing device 150 through the terrestrial network 140. A second set of data is routed from the CPD 110 to the gateway routing device 150 through the satellite network 125 via the return link. After reaching the gateway routing device 150, both sets of data then flow through a services gateway 152 which is in communication with a service provider network 160.

Different types of data are also sent from the gateway routing device 150 to the CPD 110 through both the satellite network 125 (via the gateway satellite transceiver 130) and the terrestrial network 140. A first set of data flows from the gateway routing device 150, through the terrestrial network 140, to the CPD 110. A second set of data flows from the gateway routing device 150 to the CPD 110 via the forward link of the satellite network 125.

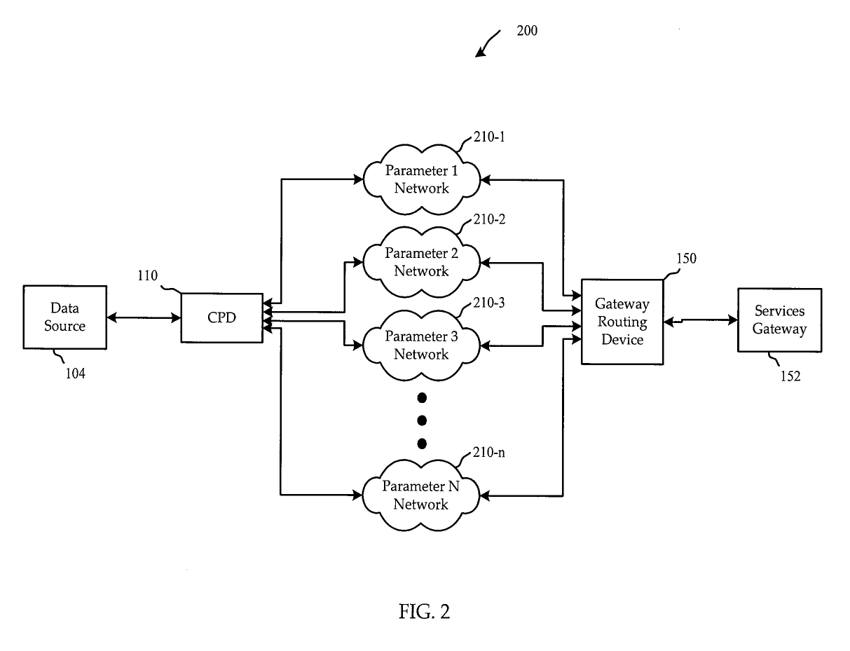

FIG. 2 provides a block diagram of an embodiment of a multi-channel network environment 200 with both a CPD 110 and a gateway routing device 150. In the multi-channel network environment 200, the CPD 110 and the gateway routing device 150 are in operative communication with each other through a number of communication networks 210. While FIG. 1 illustrates a parameter-sensitive satellite network environment 100 with only two networks (the satellite network 125 and the terrestrial network 140), adding more networks may allow more effective routing of data with different parametric sensitivities.

The CPD 110 receives data from a data source 104. The CPD 110 then determines an appropriate routing solution for the data by analyzing the parametric sensitivities of the data and the communications networks 210. Data flows through the communications networks 210 to the gateway routing device 150. From the gateway routing device 150, the data flows to a services gateway 152. In some embodiments, data is sent back from the gateway routing device 150 to the CPD 110 via the communication networks 210. The CPD 110 would then flow the data back to the data source 104.

The communication networks 210 each have different characteristics, which are more compatible with data types having certain parametric sensitivities. Further, some or all of the communication networks 210 may be of different network types. For example, the communications networks 210 may include a local area network (LAN), wide area network (WAN), Ethernet, fiber-optics, cable modem, direct-subscriber line (DSL), satellite, integrated services digital network (ISDN), dedicated network, distributed network, or any other network type.

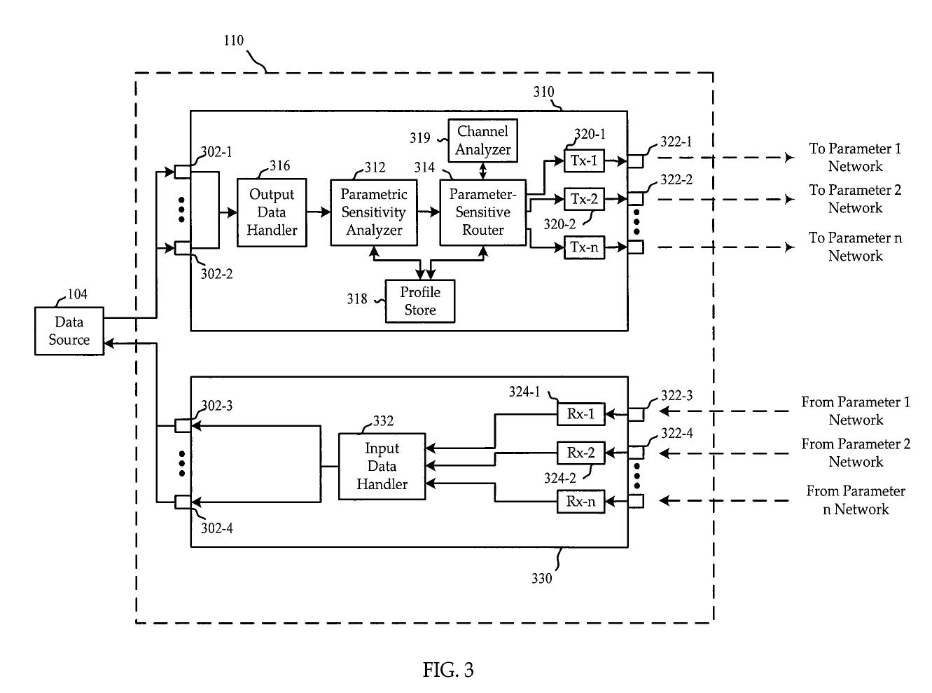

FIG. 3 provides a block diagram of an embodiment of a CPD 110. The CPD 110 includes a data output system 310 with one or more data source ports 302 and network ports 322. The data source ports 302 may be configured to connect to a data source 104. The data source 104 may include one or more sources of data and/or data channels within a larger data source, such as one or more ports from a computer. Further, some data source ports 302 may be physical ports (e.g. Ethernet ports, coaxial ports, etc.), while other data source ports 302 may be logical ports (e.g. Internet protocol ports).

Depending on the type of connected data source 104 or communications network, different types of data source ports 302 and network ports 322 may be needed. For example, a cable modem network may require only one coaxial input/output port which could send and receive data via a cable modem network. Other interfaces may require separate input and output channels, special types of interfaces, separate power connections, etc.

In some embodiments, data is received at the data source ports 302 as a single data flow. In other embodiments, data is received at the data source ports 302 and may require pre-processing into one or more data flows. Data which requires pre-processing may flow through an output data handler 316. The pre-processing by the output data handler 316 may include multiplexing, combining, encoding, decoding, verifying, de-multiplexing, or any other processing required before the data can be analyzed. After pre-processing the data, a parametric sensitivity analyzer 312 analyzes the data for sensitivity to one or more of a set of parameters (i.e., parametric sensitivity).

In some embodiments, the parametric sensitivity analyzer 312 uses information intrinsic to the data to determine the data's sensitivity to the set of parameters. For example, a particular datagram may contain a marker (e.g., header information) which relates to or defines its sensitivity to a particular parameter set. In another example, a statistical or other type of analysis of the data may reveal certain information about the data (e.g., a highly variable bit rate), which can provide information about the data's parametric sensitivity.

In other embodiments, the parametric sensitivity analyzer 312 makes an extrinsic analysis of the data by using information extrinsic to the data to determine the data's parametric sensitivity. In one embodiment, a particular data flow comes from a particular port which has a predefined profile. The profile tells the parametric sensitivity analyzer 312 that all data originating from that port is assumed to have a certain parametric sensitivity. For example, all command data relating to a particular online multi-player game may come from a first port 302-1, while all video rendering data from the game may come from a second port 302-2. In another embodiment, configuration data is sent to the parametric sensitivity analyzer 312 to configure the parametric sensitivity analyzer 312 to receive data with a certain parametric sensitivity. For example, when a computer user chooses to begin a videoconferencing session, the computer may send information to the parametric sensitivity analyzer 312 to pre-configure it to route that data appropriately.

In the extrinsic analyses, sets of profiles and related information may be stored in a profile store 318. The information in the profile store 318 may be accessed and applied by the parametric sensitivity analyzer 312 to a data flow upon certain conditions. In one embodiment, in the multi-player online game example above, the parametric sensitivity analyzer 312 detects a data flow originating from the first port 302-1. At this point, the parametric sensitivity analyzer 312 accesses a “game data” profile from the profile store 318 and applies the “game data” profile to the analysis. In another embodiment, the parametric sensitivity analyzer 312 again detects a data flow originating from the first port 302-1. The analyzer then looks to a table stored in the profile store 318 which contains a database (e.g., a relational database or a flat file) of different data flow-related information. The profile store 318 database shows that the first port 302-1 corresponds to data relating to an online multi-player game command, at which point the data store 318 returns the “game data” profile which is also stored in the profile store 318.

Hybrid analyses are also possible, which use both intrinsic and extrinsic information to determine the parametric sensitivity of data. In one embodiment, the parametric sensitivity analyzer 312 detects a data flow originating from the first port 302-1, but has no predefined information relating to data flows from this first port 302-1. The parametric sensitivity analyzer 312 then uses intrinsic information from the data flow to determine that it contains command data of a certain type. The parametric sensitivity analyzer 312 then queries the profile store 318 to find an appropriate profile to apply to the data flow.

In some embodiments of the CPD 110, the parametric sensitivity analyzer 312 attributes data for further processing by another component of the system (e.g., by the parameter-sensitive router 314, as discussed below). In one embodiment, the attribution includes adding header information to one or more datagrams to reflect certain characteristics of the data flow, like its origination port, a statistical analysis, or any other of the types of analyses described above. In another embodiment, the attribution includes flagging the data (e.g., setting a predefined bit in the datagram).

Once the data flow has been analyzed by the parametric sensitivity analyzer 312, the data passes to a parameter-sensitive router 314. The parameter-sensitive router 314 is in operative communication with a number of transmission channels 320, each connected to one or more of the network ports 322. The network ports 322 are configured to communicate with one or more communication networks. A function of the parameter-sensitive router 314 is to route all or part of the data coming from the parametric sensitivity analyzer 312 to one or more communication networks (via the transmission channels 320 and the network ports 322.

The transmission channels 320 connect the parameter-sensitive router 314 to one or more of the network ports 322. Depending on the types of networks connected to the network ports 322, the transmission channels 320 may perform different functions. In one embodiment, a first transmission channel 320-1 is a wire trace on a printed circuit board, which creates an electrical connection between the parameter-sensitive router 314 and a first network port 322-1. In another embodiment, the first transmission channel 320-1 is a buffer, configured to provide data to a communications network via the first network port 322-1 at a minimum guaranteed rate. In yet another embodiment, the first transmission channel 320-1 is an amplifier, configured to provide data to a communications network via the first network port 322-1 with the required levels and impedence.

In some embodiments of the CPD 110, the parameter-sensitive router 314 is configured substantially like a pass-through device. In this configuration, data comes from the parametric sensitivity analyzer 312 in such a way as to pass through the parameter-sensitive router 314 to an appropriate transmission channel 320 without the data being affected by the parameter-sensitive router 314.

In other embodiments of the CPD 110, the parameter-sensitive router 314 is preset with certain routing instructions. These routing instructions are then passively applied to data coming from the parametric sensitivity analyzer 312 to determine the appropriate routing of the data on certain conditions. In one embodiment, the parametric sensitivity analyzer 312 is configured to attribute data with a flag designating a specific routing path. In this embodiment, the parametric sensitivity analyzer 312 analyzes a data flow, determines that it should be routed to transmission channel 2 (320-2), and attributes the data with a “channel 2” flag. The parameter-sensitive router 314 then detects that flag and routes the data accordingly. In another embodiment, the parameter-sensitive router 314 is preset such that all data marked as control data by the parametric sensitivity analyzer 312 will be routed to transmission channel 2 (320-2). In this embodiment, the parametric sensitivity analyzer 312 analyzes a data flow, determines that it is control data (e.g., by its origination port or some other analysis), and attributes the data with a “control data” flag. The parameter-sensitive router 314 would again detect that flag and route the data accordingly.

In still other embodiments of the CPD 110, the parameter-sensitive router 314 is in operative communication with a channel analyzer 319. The channel analyzer 319 is configured to analyze one or more of the communication networks coupled to the network ports 322 (e.g., by testing data flowing through transmission channels 320) for certain network characteristics. In various embodiments, the analyses are performed at predetermined intervals (e.g., once every ten seconds, or once per day), substantially continuously (e.g., in series or parallel, with each channel analysis beginning substantially when the previous analysis ends), or in response to an analysis request (e.g., by the parameter-sensitive router 314).

Analyses may be performed on all or a portion of the communication networks coupled to the network ports 322, and may analyze some or all of a set of criteria. In one embodiment, where the channel analyses occurs once per day, a comprehensive analysis is performed of all network characteristics on all the communication networks coupled to the network ports 322. In another embodiment, the channel analyses are performed substantially continuously, and test data is sent over network ports 322 to poll the network ports 322 only for changes to key network characteristics (e.g., so as not to over-use system resources). In yet another embodiment, the channel analyses are performed as a result of a request from the parameter-sensitive router 314, and a particular subset of transmission channels 320 are analyzed for a particular subset of relevant network characteristics.

The channel analyzer 319 may also utilize other types of processing and algorithms for more effective channel analysis. In one embodiment, the channel analyzer 319 uses and/or maintains statistics, including data about previous channel analyses (e.g., data from the channel analyzer 319 may suggest that a particular channel tends to be more congested in the afternoon than during the remainder of the day). In another embodiment, the channel analyzer 319 analyzes the decisions made from its analyses to back-propagate improvements to its analyses (e.g., using a neural network or genetic algorithm).

In yet other embodiments of the CPD 110, the parameter-sensitive router 314 has access to a set of predefined channel profiles, relating to the set of network characteristics. In one embodiment, the set of predefined channel profiles are stored in a data store within the parameter-sensitive router 314 or in the profile store 318. In another embodiment, the parameter-sensitive router 314 uses previous results from the channel analyzer 319 (e.g., the last time a particular channel was analyzed) to generate the set of predefined channel profiles. The parameter-sensitive router 314 then uses one or more algorithms to determine an appropriate routing solution. After the parameter-sensitive router 314 determines an appropriate routing solution, the data is routed to one or more of the transmission channels 320. At this point, the data is sent over communications networks coupled to one or more network ports 322.

Embodiments of the CPD 110 also include a data input system 330. The data input system 330 has one or more network ports 322 and data source ports 302. The network ports 322 are configured to be coupled to one or more communication networks. In some embodiments, the communication networks of the data input system 330 are the same as the communication networks of the data output system 310. In these embodiments, the network ports 322 may be shared between the data output system 310 and the data input system 330 (e.g., network port 322-1 connects to the same network and represents the same physical port as network port 322-3). The network ports 322 may be connected to reception channels 324, which are substantially the same as the transmission channels 320.

In some embodiments of the data input system 330, the data input system 330 acts as a pass through, receiving data through one or more network ports 322 and flowing the data directly to one or more data source ports 302. The data then flows from the data source ports 302 to the data source 104.

In other embodiments of the data input system 330, the data flows through one or more elements as intermediaries between the network ports 322 and the data source ports 302, like an input data handler 332. The input data handler 332 performs one or more data processing functions on data passing through the data input system 330. In one embodiment, multiplexed data is de-multiplexed for routing to data source ports (302-3 and 302-4). In another embodiment, data is transcoded from one format or protocol into another for compatibility between the communications network where the data originated (e.g., coupled to network port 322-3) and the data source 104. In yet another embodiment, data is verified (e.g., encrypted/decrypted, compared to reference data, etc.) before passing through to the data source 104. In still another embodiment, data from multiple communication networks coupled to multiple network ports 322 requires synchronization. For example, in a certain online multi-player game, game control data is sent over a relatively low physical latency and low bandwidth network (e.g., a cable modem network), while video and audio information is sent over a relatively high physical latency and high bandwidth network (e.g., a satellite network). At some points in the data traffic, it may become necessary to wait for the video data to arrive before allowing the control data through to avoid providing an unsynchronized gaming environment to the end user. Therefore, the video and control data must be synchronized before being passed to the data source 104. The input data handler 332 may perform any useful type of data processing function, and many additional or supplemental types of intermediary components are possible. After the data is processed or otherwise handled, the data may then flow to the input system outputs 302 and then to one or more data sources 104.

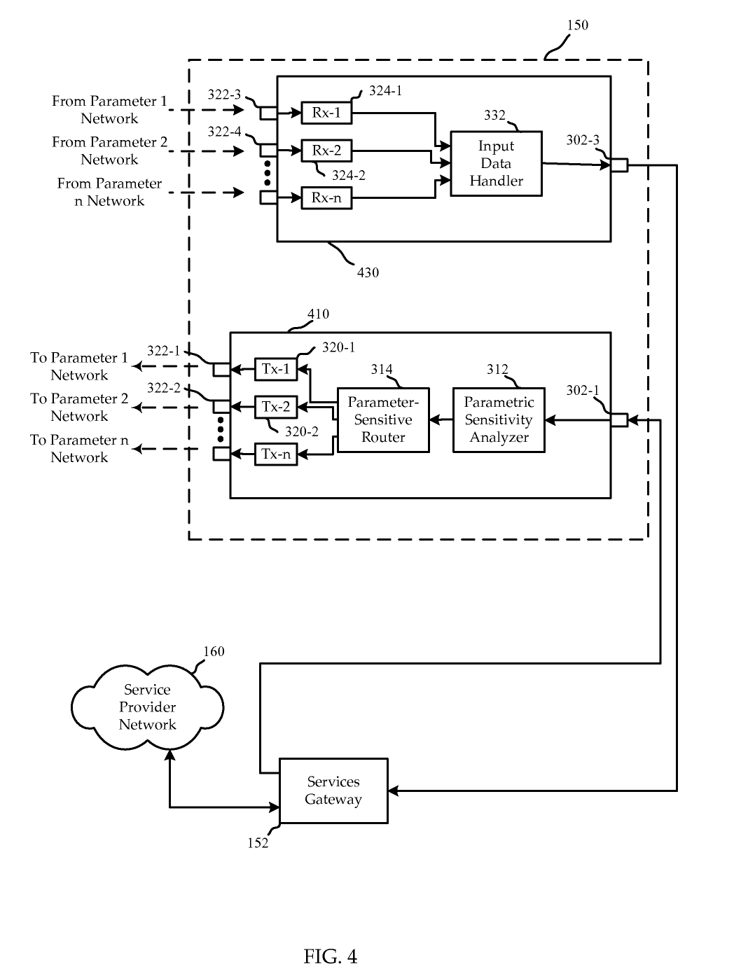

FIG. 4 provides a block diagram of an embodiment of a gateway routing device 150. The gateway routing device 150 may be any device or any part of any device capable of routing parameter sensitive data according to the various embodiments of the invention. For example, the gateway routing device 150 may be part of or may include other network components (e.g., data transceivers) and may or may not be collocated with other network routing components (e.g., voice gateways or head-ends). The gateway routing device 150 includes a data input system 430 with one or more network ports 322 and data source ports 302. The network ports 322 are configured to be coupled to one or more communication networks.

Embodiments of the data input system 430 act substantially like the data input system 330 of the CPD 110. Data flows from various communication networks, through network ports 322, through reception channels 324, through an input data handler 332, and out through the data source ports 302. From the data source ports 302, the data flows to a services gateway 152, which is in operative communication with a service provider network 160. The service provider network may include content provider networks, for example, to serve files, stream media, access to other networks, or provide other content or services.

In some embodiments of the gateway routing device 150, the gateway routing device 150 further includes a data output system 410 with one or more data source ports 302 and network ports 322. The data source ports 302 are configured to connect to one or more data providers, like the services gateway 152.

Embodiments of the data output system 410 act substantially like the data output system 310 of the CPD 110. Data is received at the data source ports 302 and may be passed through an output data handler (not shown). The data is then analyzed by a parametric sensitivity analyzer 312 for parametric sensitivity. Once the data flow has been analyzed by the parametric sensitivity analyzer 312, the data passes to a parameter-sensitive router 314. The parameter-sensitive router 314 is in operative communication with a number of transmission channels 320, each configured to communicate with one or more communication networks via one or more network ports 322. In some embodiments, the communication networks of the data input system 430 are the same as the communication networks of the data output system 410. In these embodiments, the network ports 322 may be shared between the data output system 410 and the data input system 430 (e.g., network port 322-1 connects to the same network and represents the same physical port as network port 322-3).

In addition to the embodiments provided in FIGS. 1-4, many CPD 110 and gateway routing device 150 configurations are possible. In some embodiments, all the various elements are collocated within a single device. In other embodiments, or one or more elements are separate (e.g., separate devices for the data output systems and the data input systems, or separate storage devices). In yet other embodiments, the various units of the CPD 110 and the gateway routing device 150 are provided in a combination of hardware and software. For example, some units of the devices are implemented with one or more Application Specific Integrated Circuits (ASICs) or by one or more other processing units (or cores) on one or more integrated circuits. In still other embodiments, the functions of various units are implemented with instructions embodied in a memory, formatted to be executed by one or more processors.

### Latency-Sensitive Data Routing

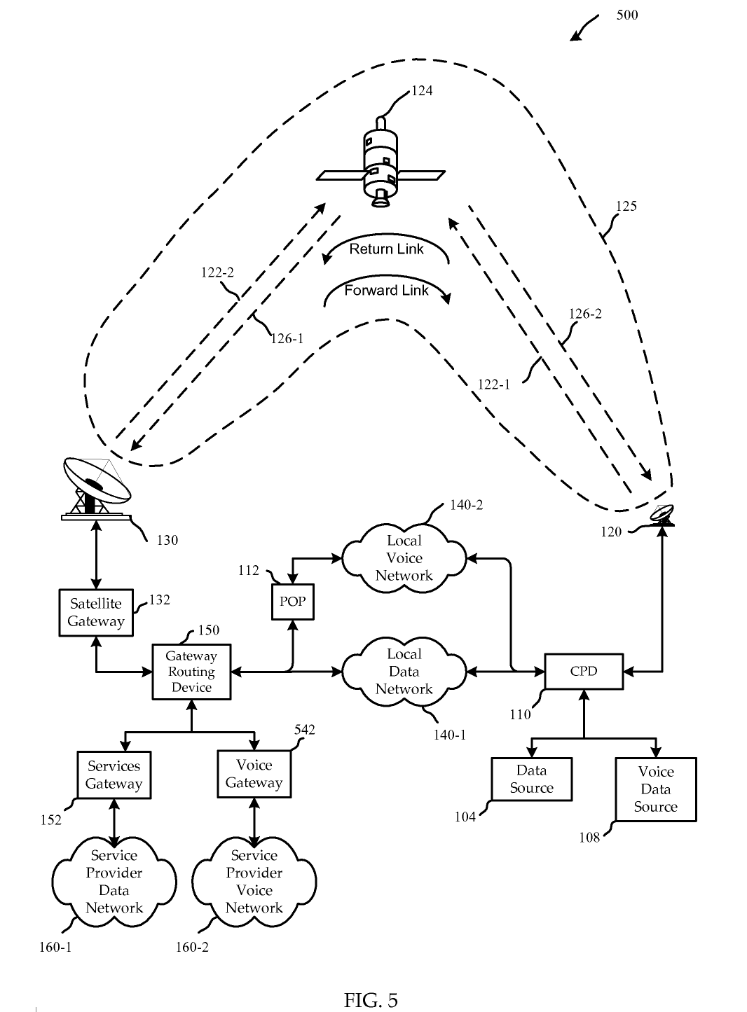

Embodiments of the invention relate to routing data based on parametric sensitivity to physical latency (i.e., physical latency sensitivity). FIG. 5 provides a block diagram of an embodiment of a latency-sensitive network environment 500. The latency-sensitive network environment 500 includes a CPD 110 and a gateway routing device 150, as in FIG. 1.

The CPD 110 is configured to receive data from a data source 104 and a voice data source 108. The CPD 110 is further configured to route data, based at least on the physical latency sensitivity of the data, to either a satellite network 125 (via a customer satellite transceiver 120 or to one or more terrestrial networks 140. The terrestrial networks 140 have lower physical latency than the satellite network coupled to the customer satellite transceiver 120. The data from the voice data source 108 is VoIP data, which is physical latency sensitive. The data from the data source 104 includes both physical latency sensitive and non-physical latency sensitive data. Therefore, the CPD 110 will route all the data from the voice data source 108 and the physical latency sensitive data from the data source 104 through the terrestrial networks 140; and the non-physical latency sensitive data from the data source 104 through the satellite network 125 coupled to the customer satellite transceiver 120.

The physical latency sensitive data from the data source 104 flows from the data source 104 to the CPD 110, through a local data network 140-1, and to the gateway routing device 150. The physical latency sensitive data then flows from the gateway routing device 150, through a services gateway 152, and to a service provider data network 160-1. In some embodiments, the local data network 140-1 is part of, or is in communication with, the service provider data network 160-1.

In some embodiments, the VoIP data flows from the voice data source 108 to the CPD 110, through a local voice network 140-2, and to the gateway routing device 150. The VoIP data then flows from the gateway routing device 150, through a voice gateway 542, and to a service provider voice network 160-2. In some embodiments, the local voice network 140-2 is part of, or is in communication with, the service provider voice network 160-2. In other embodiments, the local voice network 140-2 is part of, or is in communication with, the local data network 140-1. In one embodiment, voice data coming from the CPD 110 is made compatible with one or more of the local voice network 140-2, the gateway routing device 150, the voice gateway 542, and the service provider voice network 160-2. In this embodiment, the voice data passes through one or more internet points of presence (POPs) 112 (e.g., for protocol conversion).

In some embodiments, the non-physical latency sensitive data from the data source 104 flows from the CPD 110 through the customer satellite transceiver 120, through a satellite 124 via a satellite uplink channel 122-1, to a gateway satellite transceiver 130 via a satellite downlink channel 126-1, through a satellite gateway 132, and to the gateway routing device 150. The gateway routing device 150 then communicates the data to a services gateway 152, which is in communication with a service provider data network 160-1.

Data is also sent from the gateway routing device 650 to the CPD 606 with different physical latency sensitivities. Physical latency sensitive data flows back from the gateway routing device 150, through the local data network 140-1, and to the CPD 110. VoIP data flows back from the gateway routing device 150, through the local voice network 140-2, and to the CPD 110 (with possible passage along the way through one or more POPs 112). Non-physical latency sensitive data flows back from the gateway routing device 150 through the gateway satellite transceiver 130, through the satellite 124 via a satellite uplink channel 122-2, through the customer satellite transceiver 120 via a satellite downlink channel 126-2, and to the CPD 110.

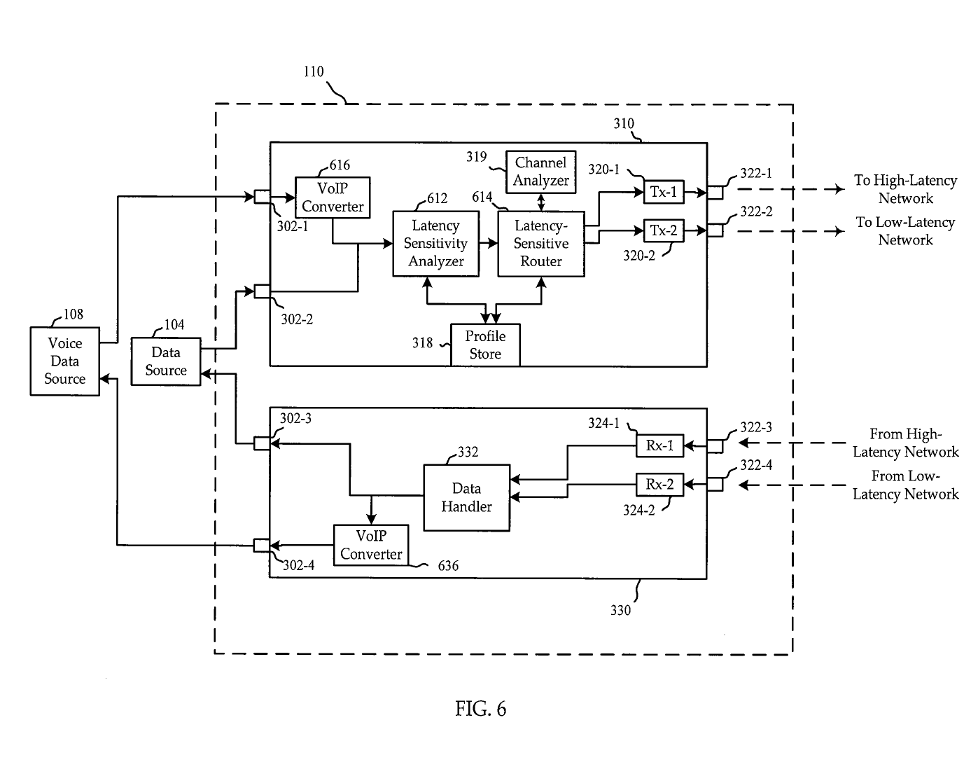

FIG. 6 provides a block diagram of another embodiment of a CPD 110, which may be used in the latency-sensitive network environment 500 of FIG. 5. The CPD 110 includes a data output system 310 with one or more data source ports 302 and a number of network ports 322. A first data source port 302-1 may be configured to connect to a data source 104, and a second data source port 302-2 may be configured to connect to a voice data source 108. A voice data source 108 may include a computer, a telephone, a microphone, or anything capable of providing voice data.

In some embodiments, data is received at the second data source port 302-2 in some voice format. This voice format may include analog or digital information representing a voice signal. Further, one or more algorithms (e.g., for transcoding, compression, etc.) may be applied to the voice data as part of the voice data format. In certain of these embodiments, the voice data format allows the voice data to be transmitted as internet-protocol data. This is commonly referred to in the art as voice-over-internet-protocol data, or VoIP data. Reference to VoIP data is not intended to be limited to any particular method, protocol, format, or data type. Rather, VoIP is used herein to generally describe voice data formatted to be compatible with Internet transmission. In some embodiments, voice data received at the second data source port 302-2 requires conversion into a VoIP format by passing the data through a VoIP converter 616.

Both the voice and other data are then analyzed by a latency sensitivity analyzer 612 for sensitivity to physical latency. Embodiments of the latency sensitivity analyzer 612 are similar to those of the parametric sensitivity analyzer 312. The latency sensitivity analyzer 612 may also analyze data for sensitivity to any number of other parameters.

Once the data flow has been analyzed by the latency sensitivity analyzer 612, the data passes to a latency-sensitive router 614. Embodiments of the latency-sensitive router 614 are similar to those of the parameter-sensitive analyzer 312. The latency-sensitive router 614 is in operative communication with a number of transmission channels 320, each configured to communicate with one or more communication networks via one or more network ports 322. Each of the communication networks 322 has different network characteristics, preferably relating to differences in physical latency.

An appropriate routing solution may require appropriate routing of the voice data coming from the voice data source 108. In some embodiments, the latency-sensitive router 614 may send all voice data over a particular network associated with a certain service provider or a certain set of criteria. Further, the voice data may be identified (e.g. flagged with metadata or header information) for more effective routing through a multi-network system.

When the latency-sensitive router 614 determines an appropriate routing solution, the data is routed through one or more transmission channels 320 to one or more network ports 322. At this point, the data is sent over one or more communications networks coupled to the network ports 322.

In some embodiments, the CPD 110 includes a data input system 330 with one or more network ports 322 and one or more data source ports 302. The network ports 322 may be connected to reception channels 324 and coupled to one or more communication networks. In certain embodiments, a data handler 332 is connected to the reception channels 324 and performs one or more data processing functions on the data coming from the reception channels 324. The data handler 332 may perform particular functions when voice data is received at the data input system 330. For example, it may be necessary to parse VoIP data from other data flows for routing to one or more voice data sources 108. Additionally, the VoIP data may be routed through a VoIP converter 636. The VoIP converter 636 may convert the VoIP data to be compatible with the voice data source 108, for example, by converting the data into an analog or digital voice data flow.

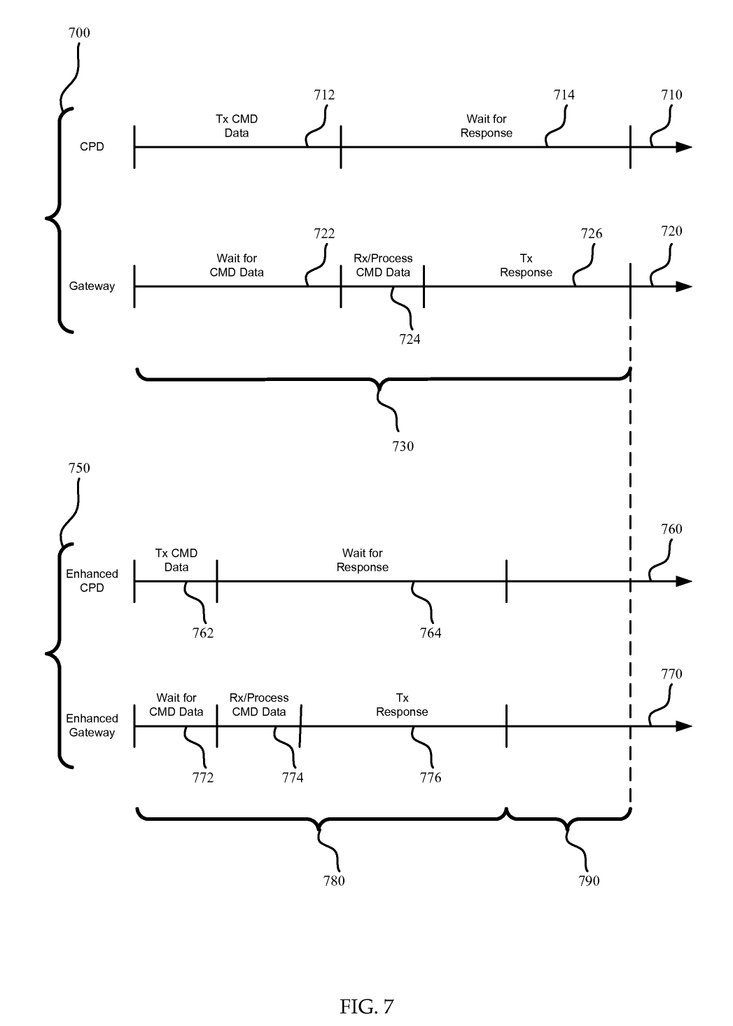

FIG. 7 provides timelines representing data flow within embodiments of the invention. Specifically, FIG. 7 represents a case, in which a CPD transmits low-bandwidth command data to a gateway and receives a high-bandwidth response from the gateway. The non-enhanced system timeline set 700 represents a network environment in which all information is communicated over a satellite network. The enhanced system timeline set 750 represents a system with physical latency-sensitive data routing capabilities, where physical latency-insensitive information is routed to a satellite communications network and physical latency-sensitive information is routed to a DSL network.

The non-enhanced system timeline set 700 provides a non-enhanced CPD timeline 710 and a non-enhanced gateway timeline 720. The CPD begins in the first non-enhanced CPD time block 712 by transmitting command data to the gateway over a satellite network. FIG. 7 assumes that all transmissions over a satellite network take approximately 250 milliseconds. This assumption is based on the following approximate calculations: Information must travel 44,000 miles round-trip in a one-way satellite communication; at the speed of light (the theoretical maximum speed of information travel), this would take 237 milliseconds; so 250 milliseconds accounts for this information travel time and any other system delays.

The gateway begins in the first non-enhanced gateway time block 722 by waiting to receive the command data from the CPD over the satellite network (250 ms). In the second non-enhanced gateway time block 724, the command data is received and processed, and a response is prepared for transmission (assuming 50 ms). In the third non-enhanced gateway time block 726, the response is transmitted from the gateway to the CPD over the satellite network (250 ms).

In the second non-enhanced CPD time block 714, the CPD waits for and finally receives the response from the gateway (300 ms). The total non-enhanced communication time 730 is therefore 550 milliseconds from the beginning of the CPD transmission to the receipt of the gateway response.

The enhanced system timeline set 750 provides an enhanced CPD timeline 760 and an enhanced gateway timeline 770. According to the illustrated case, the CPD begins in the first enhanced CPD time block 762 by transmitting command data to the gateway over a DSL network. We assume that all transmissions over a DSL network take approximately 75 milliseconds (typical for many such systems). The DSL network is used here because the command data is low bandwidth and does not require the bandwidth capabilities of a satellite network.

The gateway begins in the first enhanced gateway time block 772 by waiting to receive the command data from the CPD over the DSL network (75 ms). In the second enhanced gateway time block 774, the command data is received and processed, and a response is prepared for transmission (assuming 50 ms). In the third enhanced gateway time block 776, the response is transmitted from the gateway to the CPD over the satellite network (250 ms). The satellite network is used here for the response because the response includes a high bandwidth data flow, which benefits from the capabilities of a satellite network.

In the second enhanced CPD time block 764, the CPD waits for and finally receives the response from the gateway (300 ms). The total enhanced communication time 780 is therefore 375 milliseconds from the beginning of the CPD transmission to the receipt of the gateway response. This corresponds to a total transmission time savings 790 of 175 milliseconds.

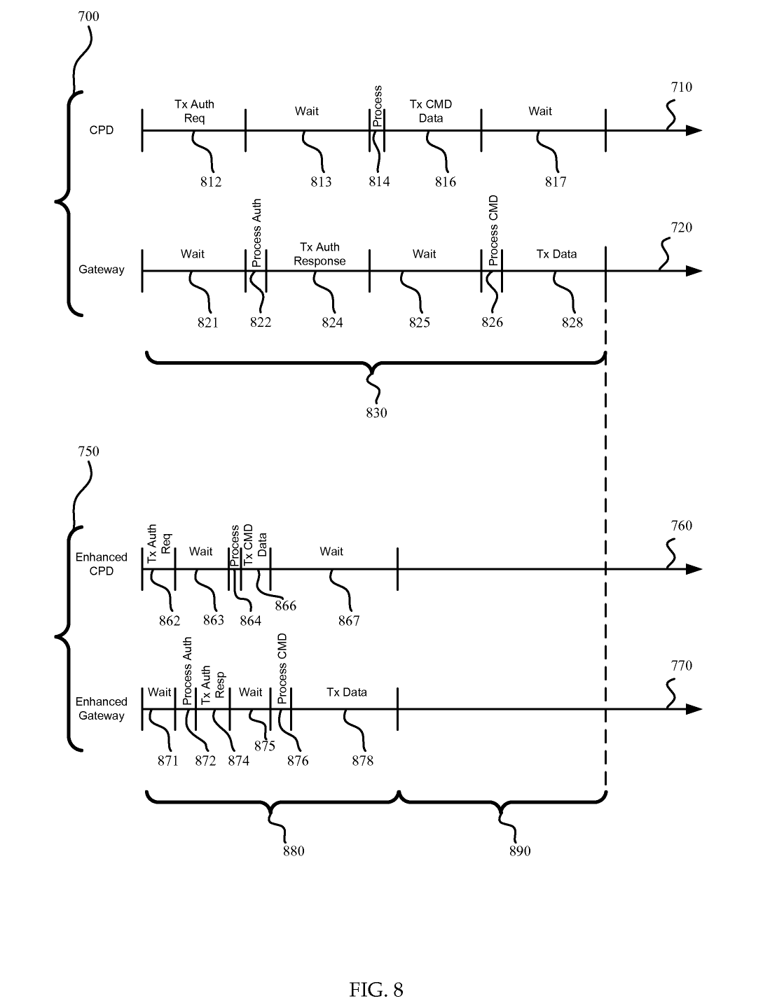

FIG. 8 provides other timelines representing data flow within embodiments of the invention. Specifically, FIG. 8 represents a purely illustrative case, in which a CPD transmits an authorization request to a gateway, waits for authorization from the gateway, sends command data to the gateway, and receives some desired response from the gateway. FIG. 8 assumes that all the authorization information and request command are low bandwidth data flows, and the gateway response includes a high bandwidth data flow. Again, the non-enhanced system timeline set 700 represents a network environment in which all information is communicated over a satellite network. The enhanced system timeline set 750 represents a system with physical latency-sensitive data routing capabilities, where physical latency-insensitive information is routed to a satellite communications network and physical latency-sensitive information is routed to a DSL network.

The non-enhanced system timeline set 700 provides a non-enhanced CPD timeline 710 and a non-enhanced gateway timeline 720. According to the illustrated case, the CPD begins in the first non-enhanced CPD time block 812 by transmitting an authorization request to the gateway over a satellite network, taking approximately 250 milliseconds.

The gateway begins in the first non-enhanced gateway time block 821 by waiting to receive the authorization request from the CPD over the satellite network (250 ms). In the second non-enhanced gateway time block 822, the authorization request is received and processed, and a response is prepared for transmission (assuming 50 ms). In the third non-enhanced gateway time block 824, the authorization response is transmitted from the gateway to the CPD over the satellite network (250 ms).

In the second non-enhanced CPD time block 813, the CPD waits for and receives the authorization response from the gateway (300 ms). At that point, in the third non-enhanced CPD time block 814, the CPD processes receipt of the authorization (assuming 10 ms). In the fourth non-enhanced CPD time block 816, the CPD transmits a request command to the gateway over the satellite network (250 ms).

In the fourth non-enhanced gateway time block 825, the gateway waits to receive the command request from the CPD over the satellite network (260 ms). In the fifth non-enhanced gateway time block 826, the command request is received and processed, and a response is prepared for transmission (assuming 50 ms). In the sixth non-enhanced gateway time block 828, the authorization response is transmitted from the gateway to the CPD over the satellite network (250 ms).

In the fifth non-enhanced CPD time block 817, the CPD waits for and receives the response from the gateway (300 ms). The total non-enhanced communication time 830 is therefore 1110 milliseconds from the beginning of the CPD authorization request to the receipt of the gateway response.

The enhanced system timeline set 750 provides an enhanced CPD timeline 760 and an enhanced gateway timeline 770. According to the illustrated case, the CPD begins in the first enhanced CPD time block 862 by transmitting an authorization request to the gateway over a DSL network, taking approximately 75 milliseconds.

The gateway begins in the first enhanced gateway time block 871 by waiting to receive the authorization request from the CPD over the DSL network (75 ms). In the second enhanced gateway time block 872, the authorization request is received and processed, and a response is prepared for transmission (assuming 50 ms). In the third enhanced gateway time block 874, the authorization response is transmitted from the gateway to the CPD over the DSL network (75 ms).

In the second enhanced CPD time block 863, the CPD waits for and receives the authorization response from the gateway (125 ms). At that point, in the third enhanced CPD time block 864, the CPD processes receipt of the authorization (assuming 10 ms). In the fourth enhanced CPD time block 866, the CPD transmits a request command to the gateway over the DSL network (75 ms).

In the fourth enhanced gateway time block 875, the gateway waits to receive the command request from the CPD over the DSL network (85 ms). In the fifth enhanced gateway time block 876, the command request is received and processed, and a response is prepared for transmission (assuming 50 ms). In the sixth enhanced gateway time block 878, the authorization response is transmitted from the gateway to the CPD over the satellite network (250 ms). Until this point in the communication, only the DSL network has been used because the transmissions have involved only very low-bandwidth data flows. However, the response data is transmitted over the satellite network to exploit the high bandwidth capability of that network.

In the fifth enhanced CPD time block 867, the CPD waits for and receives the response from the gateway (300 ms). The total enhanced communication time 880 is therefore 585 milliseconds from the beginning of the CPD authorization request to the receipt of the gateway response. This corresponds to a total transmission time savings 890 of 525 milliseconds (approximately a 47% savings).

### Parameter-Sensitive Data Routing Methods

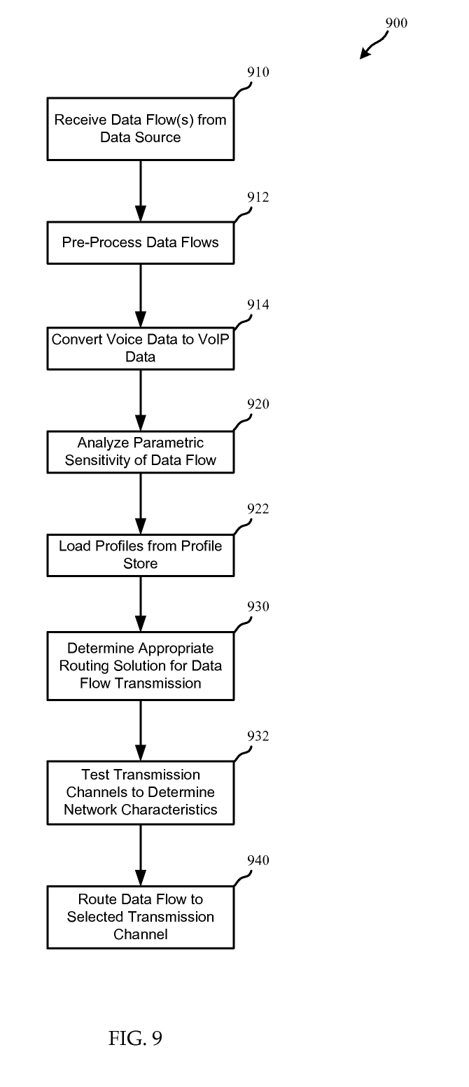

FIG. 9 provides a flow diagram of an embodiment of a method 900 for routing parameter-sensitive data. The method 900 begins at block 910 by receiving one or more data flows from one or more data sources.

In some embodiments, data is received at block 910 as a single data flow. In other embodiments, however, data is received at block 910 and may require pre-processing at block 912 into one or more data flows. For example, parts of a data flow coming from multiple data sources may be multiplexed, combined, encoded, decoded, verified, demultiplexed, or otherwise pre-processed.

In certain embodiments, voice data is transmitted as internet-protocol data (e.g., as VoIP data). In some of these embodiments, before or after pre-processing the data at block 912, the voice data is converted at block 914 into VoIP data.

The data (and the voice data, in some cases) is then analyzed at block 920 by a parametric sensitivity analyzer for sensitivity to any number of parameters. In some embodiments, the analysis at block 920 involves using information intrinsic to the data to determine the data's sensitivity to the set of parameters. For example, data may contain certain attributes or markers, statistical analyses may be employed, etc. In other embodiments, the analysis at block 920 involves using information extrinsic to the data to determine the data's sensitivity to the set of parameters. For example, the analysis at block 920 may look at the originating port of the data, configuration or other data may be communicated to aid in the analysis, etc. Further, after the analysis at block 920, one or more data flow profiles may be loaded at block 922 from a profile store. Hybrid analyses are also possible, which utilize both intrinsic and extrinsic information in making the analysis at block 920.

After performing the analysis at block 920, the method 900 may determine an appropriate routing solution for the data at block 930. In some embodiments, the determination at block 930 involves selecting a transmission channel from among a number of transmission channels over which to send all or part of the data flow.

The determination at block 930 may be accomplished in many different ways according to the present invention. In some embodiments, the determination at block 930 is substantially passive, for example, using preset routing instructions (e.g., attributes or flags) to select an appropriate transmission channel.

In other embodiments, the determination at block 930 is more active. For example, the determination at block 930 may use a set of pre-determined network characteristics (or profiles) or the method 900 may test one or more of the number of transmission channels at block 932 to determine the network characteristics. The testing at block 932 may be performed at any useful time, in any useful way, and on all or only a portion of the channels.

The set of network characteristics may include any characteristic useful for making the determination at block 930, including, for example, sensitivities to cost per bit, network congestion, physical latency, packet loss, access rights, certain types of routing protocols, predefined or stored algorithms, priority, or any other relevant parameter associated with a transmission channel. Further, the set of network characteristics may be the same or different from the set of data flow parameters.

After making the determination at block 930, the method 900 may route all or part of the data at block 940 to one or more transmission channels based on the determination at block 930. At this point, the data is sent over one or more communications networks.

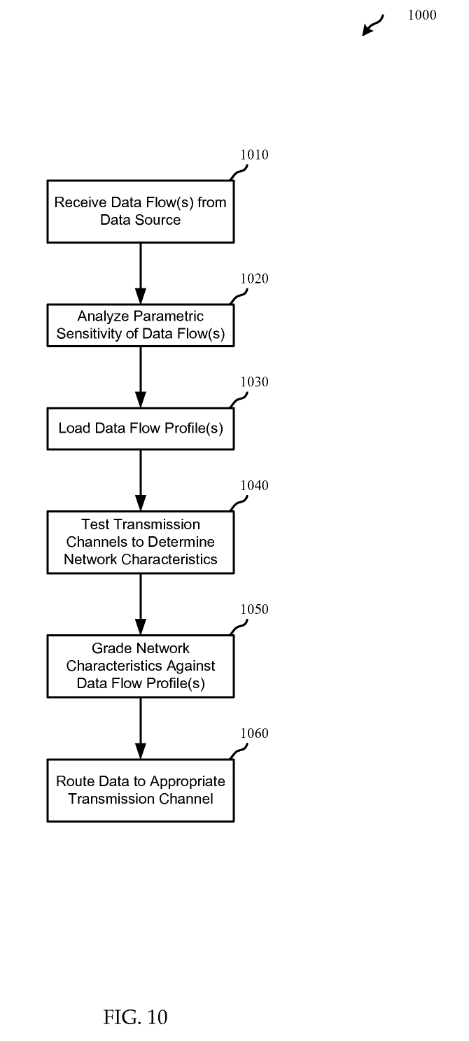

FIG. 10 provides another flow diagram of an embodiment of a method 1000 for routing parameter-sensitive data. The method 1000 begins by receiving data flows from a data source at block 1010. At block 1020, the method 1000 then analyzes the data which was received at block 1010 to determine its parametric sensitivity. After analyzing the data at block 1020, the method 1000 loads a set of data flow profiles at block 1030 corresponding at least to the data flows which were received at block 1010. At block 1040, the method 1000 then tests available transmission channels to determine network characteristics. Using the data flow profiles loaded at block 1030, and the network characteristics tested at block 1040, the method 1000 then grades the network characteristics against the data flow profiles at block 1050. After the grading at block 1050, the method 1000 routes all or part of the data to one or more transmission channels at block 1060. At this point, the data is sent over one or more communications networks.

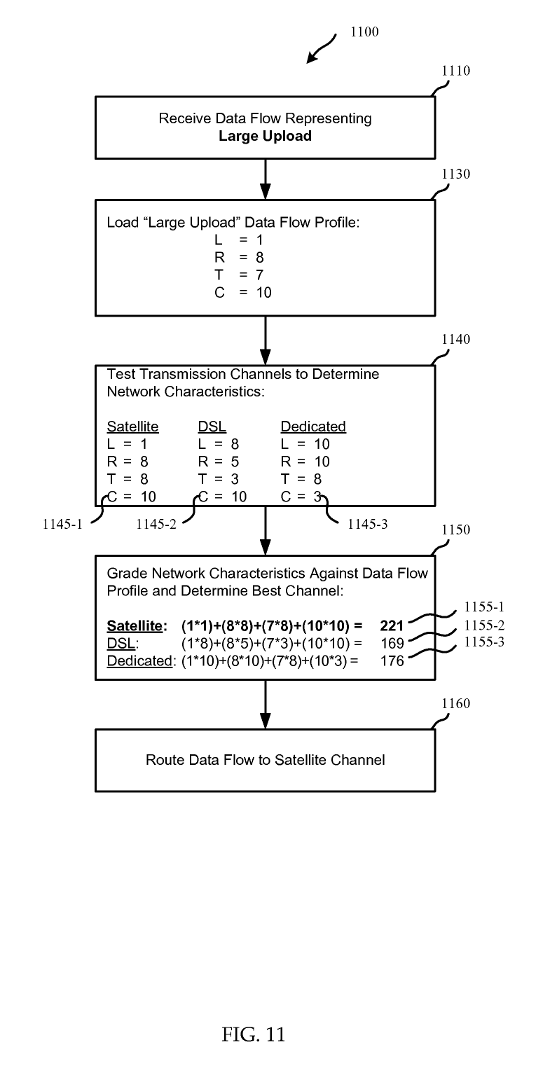

FIG. 11 provides a flow diagram of an embodiment of a method 1100 for routing large upload data. The method 1100 begins at block 1110 by receiving a data flow which represents a large upload. For example, the data flow may represent a large movie file being sent to a server over a network.

At block 1130, the method 1100 then loads a data profile corresponding to “large upload” data flows. This data flow profile may have been created and stored in any useful way. For example, the data flow profile may have been preset by a system administrator or a user, or even learned by a device or system as a result of similar repeated data flow transmissions.

This method 1100, assumes that the data profile includes at least four data parameters: physical latency, reliability, traffic, and cost per bit (represented by the letters L, R, T, and C, respectively). Each of these parameters is associated with a score of 1 through 10; with 1 representing a low sensitivity to the parameter and 10 representing a high sensitivity to the parameter. In this case, the “Large Upload” data flow profile assumes a very low sensitivity to physical latency (e.g., it is unimportant if there is a lag between the beginning of transmission and the beginning of reception); fairly high sensitivities to reliability and traffic (e.g., it would be undesirable to have significant packet loss, high network traffic, etc.); and very high sensitivity to cost per bit (e.g., it would be very expensive to send the many bits in a large upload if there is a high cost per bit on the channel).

At block 1140, the method 1100 then tests available transmission channels to determine network characteristics. According to this illustration, the network characteristics include at least the four data parameters: physical latency, reliability, traffic, and cost per bit (represented by the letters L, R, T, and C, respectively). Again, each of these parameters is associated with a score of 1 through 10; with 1 representing the worst rating with respect to that parameter and 10 representing the best rating with respect to that parameter. For example, a physical latency rating of 1 indicates that there is very high physical latency on the tested channel, while a reliability rating of 1 indicates very low reliability on the channel (e.g., high packet loss or error rate).

Three channels are tested at block 1140. The first channel test (block 1145-1) tests a satellite network, with a physical latency rating of 1 (very high physical latency), a reliability rating of 8 (high reliability), a traffic rating of 8 (low traffic), and a cost rating of 10 (very low cost per bit, e.g., fixed cost). The second channel test (block 1145-2) tests a DSL network, with a physical latency rating of 8 (low physical latency), a reliability rating of 5 (medium reliability), a traffic rating of 3 (high traffic), and a cost rating of 10 (low cost per bit). The third channel test (block 1145-3) tests a dedicated network (e.g., a dedicated high-bandwidth line between two offices), with a physical latency rating of 10 (very low physical latency), a reliability rating of 10 (very high reliability), a traffic rating of 8 (low traffic), and a cost rating of 3 (high cost per bit).

Using the data flow profiles loaded at block 1130 and the network characteristics tested at block 1140, the method 1100 then grades the network characteristics against the data flow profiles at block 1150. The grading algorithm is a weighted sum, wherein each data flow parameter is multiplied by each channel characteristic rating, and then the results are summed together. This generates a single number score for each channel. A higher score indicated a more optimal solution for routing the data flow.

The first grading (block 1155-1) yields a score of 221 for the channel associated with the satellite network; the second grading (block 1155-2) yields a score of 169 for the channel associated with the DSL network; and the third grading (block 1155-3) yields a score of 176 for the channel associated with the dedicated network.

After the grading at block 1150, the method 1100 routes all or part of the data to an appropriate transmission channel at block 1160. Here, the first grading (block 1155-1), representing use of the satellite network, yielded the highest score. Therefore, the large upload data flow is routed through the satellite network at block 11160.

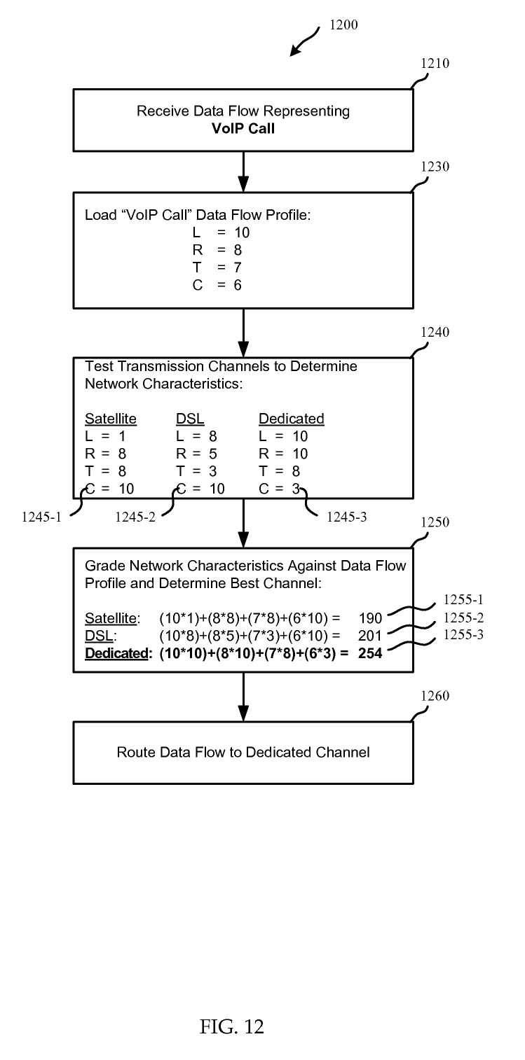

FIG. 12 provides a flow diagram of an embodiment of methods for routing VoIP data. The method 1200 begins by receiving a data flow which represents a VoIP call at block 1210. At block 1230, the method 1200 then loads a data profile corresponding to “VoIP call” data flows. The “VoIP call” data flow profile assumes a very high sensitivity to physical latency (e.g., it is very important to experience no lag in the communication); fairly high sensitivities to reliability and traffic (e.g., it would be undesirable to have significant packet loss, high network traffic, etc.); and medium sensitivity to cost per bit (e.g., cost is not a significant factor, but it is somewhat important).

At block 1240, the method 1200 then tests available transmission channels to determine network characteristics. Again, three channels are tested at block 1240 with the exact results of the testing in block 1140 (see FIG. 11). Using the data flow profiles loaded at block 1230 and the network characteristics tested at block 1240, the method 1200 then grades the network characteristics against the data flow profiles at block 1250, again by weighted sum. The first grading (block 1255-1) yields a score of 190 for the channel associated with the satellite network; the second grading (block 1255-2) yields a score of 201 for the channel associated with the DSL network; and the third grading (block 1255-3) yields a score of 254 for the channel associated with the dedicated network.

After the grading at block 1250, the method 1200 routes all or part of the data to an appropriate transmission channel at block 1260. The third grading (block 1255-3), representing the dedicated network, yielded the highest score. Therefore, the VoIP data flow is routed through the dedicated network at block 1260.

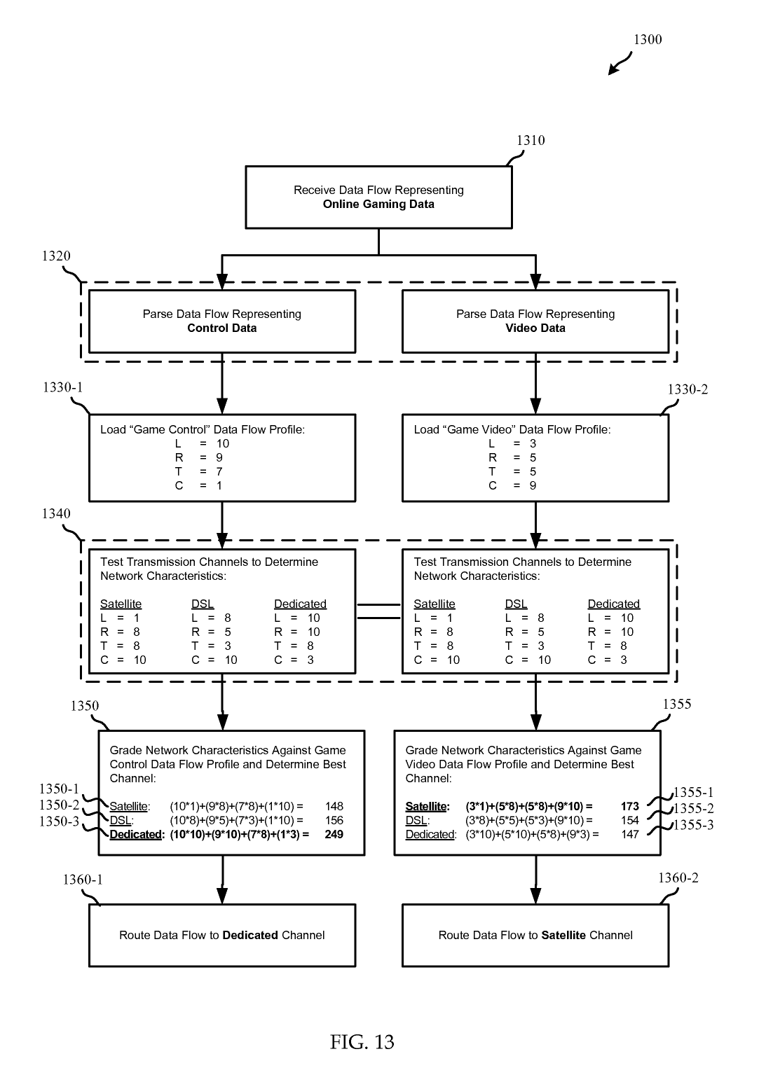

FIG. 13 provides a flow diagram of an embodiment of methods for routing online gaming data. At block 1310, the method 1300 begins by receiving a data flow which represents online gaming data. For example, the data may relate to a multi-player game in which real-time game data is communicated between players over the Internet. The data is assumed to include both low-bandwidth control data and high-bandwidth video data. Because it may be desirable to treat each type of data separately, the method 1300 parses the control data and the video data at block 1320.

At blocks 1330, the method 1300 then loads two data profiles, the first loading (block 1330-1) corresponding to the parsed “Game Control” data and the other loading (block 1330-2) corresponding to the parsed “Game Video” data. In this case, the “Game Control” data flow profile assumes a very high sensitivity to physical latency (e.g., it is very important to experience no lag in the communication); very high sensitivity to reliability (e.g., it is important that the command data is not lost or corrupted in transmission); fairly high sensitivity to traffic (e.g., it would be undesirable to experience high network traffic); and low sensitivity to cost per bit (e.g., very small amounts of data are communicated, so cost is not a significant factor). The “Game Video” data flow profile assumes a fairly low sensitivity to physical latency (e.g., it is not critical if there is some lag in the communication); medium sensitivity to reliability (e.g., some loss or corruption will not have a huge impact on the transmission); medium sensitivity to traffic (e.g., it is desirable to avoid traffic, but not critical); and high sensitivity to cost per bit (e.g., it would be very expensive to send the many bits of video data if there is a high cost per bit on the channel).

At block 1340, the method 1300 then tests available transmission channels to determine network characteristics. Three channels are tested at block 1340 with the exact results of the testing at block 1140 (see FIG. 11). Using the data flow profiles loaded at block 1330 and the network characteristics tested at block 1340, the method 1300 then grades the network characteristics against the game control data flow profile at block 1350, and grades the network characteristics against the game video data flow profile at block 1355. Again, the grading algorithm is a weighted sum. For the control data grading at block 1350, the first grading (block 1350-1) yields a score of 148 for the channel associated with the satellite network; the second grading (block 1350-2) yields a score of 156 for the channel associated with the DSL network; and the third grading (block 1350-3) yields a score of 249 for the channel associated with the dedicated network. For the video data grading at block 1355, the first grading (block 1355-1) yields a score of 173 for the channel associated with the satellite network; the second grading (block 1355-2) yields a score of 154 for the channel associated with the DSL network; and the third grading (block 1355-3) yields a score of 147 for the channel associated with the dedicated network.

After the grading at blocks 1350 and 1355, the method 1300 may route all or part of each data flow to an appropriate transmission channel at block 1360. Here, the third control data grading (block 1350-3), representing the dedicated network, yielded the highest score for the control data. Therefore, the control data flow is routed through the dedicated network at block 1360-1. For the video data, however, the first grading (block 1355-1), representing the satellite network, yielded the highest score. Therefore, the video data flow would be routed through the satellite network at block 1360-2.

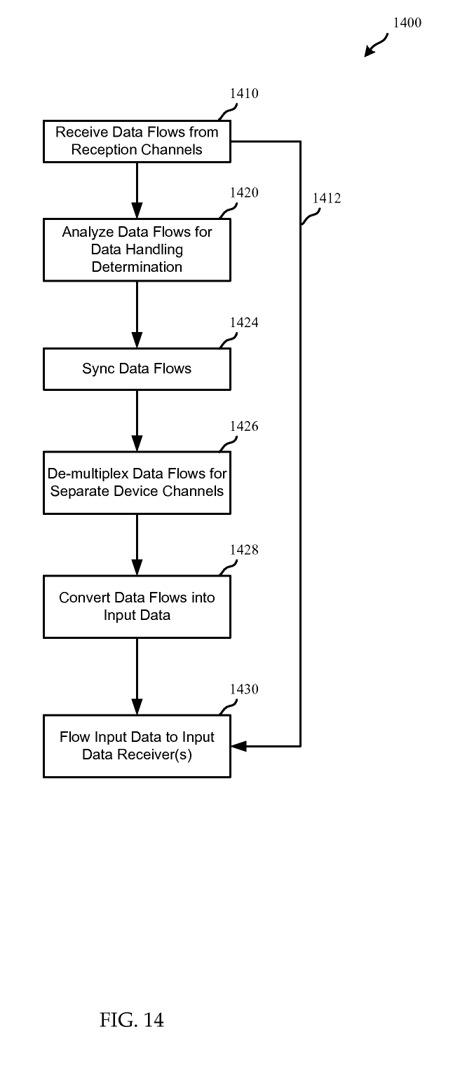

In certain embodiments of the invention, data routing methods receive parameter-sensitive data from multiple networks. FIG. 14 provides a flow diagram of an embodiment of a method 1400 for receiving parameter-sensitive data. The method 1400 begins by receiving data flows from multiple communication networks through one or more reception channels at block 1410. In some embodiments, the method 1400 analyzes the data flows at block 1420 to make a data handling determination. The analyzing at block 1420 may include performing any useful pre-processing, post-processing, routing, analytical, or other function on or using the data flows. In certain embodiments, after receiving data flows at block 1410, the method 1400 may synchronize multiple data flows at block 1424, de-multiplex a data flow into multiple data flows at block 1426, convert one or more data flows into input data for compatibility with a data receiver at block 1428 (e.g., convert VoIP data into voice data compatible with a voice data receiver), or perform any other useful data processing function. After analyzing the data flows at block 1420, the method 1400 may use all or part of that data handling determination to flow the data to one or more data receivers at block 1430. In other embodiments, after receiving the data flows at block 1410, the data is passed through 1412 to one or more data receivers at block 1430 without making any data handling determinations at blocks 1420 through 1428.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

It should also be appreciated that the following systems, methods, and software may individually or collectively be components of a larger system, wherein other procedures may take precedence over or otherwise modify their application. Also, a number of steps may be required before, after, or concurrently with the following embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Moreover, as disclosed herein, a data store may represent one or more devices for storing data, including read-only memory (ROM), random access memory (RAM), magnetic RAM, core memory, magnetic disk storage mediums, optical storage mediums, flash memory devices, or other computer-readable mediums for storing information.

Embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A customer premises device for routing latency sensitive data in a satellite communications system, comprising:
an output data channel configured to receive output data from an output data source;
a voice output channel configured to receive output voice-over-internet-protocol data from a voice-over-internet-protocol data source;
a plurality of transmission channels, at least one of which being configured for communication with a first data transmission system, and at least another of which being configured for communication with a second data transmission system, wherein the first data transmission system comprises a satellite transmitter and the second data transmission system has lower physical latency than the first data transmission system;
an analyzer in operative communication with the output data channel and the voice output channel, wherein the analyzer is configured to:
determine the latency sensitivity of at least a portion of the output data, and
determine the appropriate routing for the output voice-over-internet-protocol data; and
a router in operative communication with the analyzer and configured to route the portion of output data to at least one of the communication channels, based at least in part on the determinations of the analyzer.

2. The customer premises device for routing latency sensitive data in a satellite communications system as recited in claim 1, wherein a first subset of the plurality of communication channels is configured for transmitting output data and a second subset of the plurality of communication channels is configured for receiving input data, the input data comprising input voice-over-internet-protocol data; and
the device further comprises:
a data handler, in operative communication with the second subset of communication channels, and configured to parse the input voice-over-internet-protocol data from the input data;
an input data channel, in operative communication with the data handler, and configured to transmit the input data to the output data source; and
an input voice channel, in operative communication with the data handler, and configured to transmit the input voice-over-internet-protocol data to the voice-over-internet-protocol data source.

3. The customer premises device for routing latency sensitive data in a satellite communications system as recited in claim 1, further comprising a voice to internet-protocol converter configured to:
receive voice data from a voice data source;
convert the received voice data to input voice-over-internet-protocol data; and
transmit the input voice-over-internet-protocol data to the voice-over-internet-protocol data source.

4. The customer premises device for routing latency sensitive data in a satellite communications system as recited in claim 1, wherein the second data transmission system comprises a terrestrial communications system.

5. A method for routing latency sensitive data in a satellite communications system, comprising:
receiving output data from an output data source;
receiving output voice-over-internet-protocol data from a voice-over-internet-protocol data source;
determining the latency sensitivity of at least a portion of the output data;
determining the appropriate routing for the output voice-over-internet-protocol data;
routing the portion of output data to at least one of a plurality of communication channels, based at least in part on the determining steps;
wherein:
at least one of the plurality of communication channels is configured for communication with a first data transmission system;
at least another of the plurality of communication channels is configured for communication with a second data transmission system;
the first data transmission system comprises a satellite transmitter; and
the second data transmission system has lower physical latency than the first data transmission system.

6. The method for routing latency sensitive data in a satellite communications system as recited in claim 5, wherein a first subset of the plurality of communication channels is configured for transmitting output data and a second subset of the plurality of communication channels is configured for receiving input data, the input data comprising input voice-over-internet-protocol data; and
the method further comprises:
parsing the input voice-over-internet-protocol data from the input data;
transmitting the input data to the output data source; and
transmitting the input voice-over-internet-protocol data to the voice-over-internet-protocol data source.

7. The method for routing latency sensitive data in a satellite communications system as recited in claim 5, further comprising:
receiving voice data from a voice data source;
converting the received voice data to input voice-over-internet-protocol data; and
transmitting the input voice-over-internet-protocol data to the voice-over-internet-protocol data source.

8. A customer premises device for routing parameter sensitive data in a satellite communications system, comprising:
an output data channel configured to receive output data from an output data source;
a plurality of transmission channels, at least one of which being configured for transmission to a first data transmission system characterized by a first system profile relating to a predefined set of system parameters, and at least another of which being configured for transmission to a second data transmission system characterized by a second system profile relating to the set of system parameters,
wherein at least one of the set of system parameters relates to physical latency;
a data flow analyzer in operative communication with the output data channel and configured to determine the parametric sensitivity of at least a portion of the output data; and
a router in operative communication with the analyzer and configured to route the portion of output data to at least one of the communication channels, based at least in part on the determination of the analyzer.

9. The customer premises device for routing parameter sensitive data in a satellite communications system as recited in claim 8, further comprising:
a plurality of reception channels, at least one of which being configured to receive data from a first data reception system characterized by a third system profile relating to the set of system parameters, and at least another of which being configured to receive data from a second data reception system characterized by a fourth system profile relating to the set of system parameters;
a data handler, in operative communication with the plurality of reception channels, wherein the data handler is configured to:
analyze at least a portion of the received data to make a data handling determination, and
convert at least a portion of the received data into input data, the input data being compatible with an input data receiver; and
an input data channel, in operative communication with the data handler and the input data receiver, and configured to transmit at least a portion of the input data to the input data receiver.

10. The customer premises device for routing parameter sensitive data in a satellite communications system as recited in claim 9, further comprising a first data system and a second data system, the first data system comprising the first data transmission system and the first data reception system, and the second data system comprising the second data transmission system and the second data reception system.

11. The customer premises device for routing parameter sensitive data in a satellite communications system as recited in claim 8, wherein the portion of output data comprises at least a portion of the parametric sensitivity data, and the determination of the analyzer is based at least in part on the portion of parametric sensitivity data.

12. The customer premises device for routing parameter sensitive data in a satellite communications system as recited in claim 8, wherein the set of system parameters comprises a latency rating representing an amount of physical latency experienced by data flowing through at least a portion of a represented system.

13. The customer premises device for routing parameter sensitive data in a satellite communications system as recited in claim 8, wherein the set of system parameters comprises a cost rating representing an amount of cost associated with sending or receiving a certain quantity of data through at least a portion of a represented system.

14. The customer premises device for routing parameter sensitive data in a satellite communications system as recited in claim 8, wherein the set of system parameters comprises a congestion rating representing an amount of congestion experienced by data flowing through at least a portion of a represented system.

15. The customer premises device for routing parameter sensitive data in a satellite communications system as recited in claim 8, wherein the set of system parameters comprises a reliability rating representing an estimated change in data integrity experienced by data flowing through at least a portion of a represented system.

16. The customer premises device for routing parameter sensitive data in a satellite communications system as recited in claim 8, wherein the set of system parameters comprises a protocol rating representing an effect of one or more protocols experienced by data flowing through at least a portion of a represented system.

17. The customer premises device for routing parameter sensitive data in a satellite communications system as recited in claim 8, further comprising a channel tester configured to evaluate a system profile associated with a tested transmission channel.

18. The customer premises device for routing parameter sensitive data in a satellite communications system as recited in claim 9, wherein the data handling determination comprises data processing actions relating to at least one of data synchronization, data routing, or data de-multiplexing.

19. A gateway device for routing latency sensitive data, comprising:
a plurality of reception channels, at least one of which being configured to receive data from a first data reception system characterized by a first system profile relating to a predefined set of system parameters, and at least another of which being configured to receive data from a second data reception system characterized by a second system profile relating to the set of system parameters,
wherein at least one of the set of system parameters relates to physical latency;
a data handler, in operative communication with the plurality of reception channels, wherein the data handler is configured to:
analyze at least a portion of the received data to make a data handling determination, and
convert at least a portion of the received data into input data, the input data being compatible with an input data receiver; and
an input data channel, in operative communication with the data handler and the input data receiver, and configured to transmit at least a portion of the input data to the input data receiver.

20. The gateway device for routing latency sensitive data as recited in claim 19, further comprising:
a services gateway, in operative communication with the input data receiver, and configured to provide output data related at least in part to the input data;
an output data channel, in operative communication with the services gateway, and configured to receive at least a portion of the output data from the services gateway;
a plurality of transmission channels, at least one of which being configured for transmission to a first data transmission system characterized by a third system profile relating to the set of system parameters, and at least another of which being configured for transmission to a second data transmission system characterized by a fourth system profile relating to the set of system parameters;
a parametric sensitivity analyzer in operative communication with the output data channel and configured to determine the parametric sensitivity of at least a portion of the output data; and
a parameter-sensitive router in operative communication with the parametric sensitivity analyzer and configured to route the portion of output data to at least one of the transmission channels, based at least in part on the determination of the parametric sensitivity analyzer.

21. The gateway device for routing latency sensitive data as recited in claim 19, further comprising:
a first gateway, in operative communication with the first data reception system and the data handler, and configured to receive data from the first data reception system; and
a second gateway, in operative communication with the second data reception system and the data handler, and configured to receive data from the second data reception system;
wherein at least a portion of the data received from the second data reception system comprises voice-over-internet-protocol data.

22. A method for routing parameter sensitive data, comprising:
receiving output data from a data source;
determining parametric sensitivity of at least a portion of the output data based at least in part on a set of parametric sensitivity criteria; and
routing the portion of output data to one of a plurality of transmission channels based at least in part on the parametric sensitivity,
wherein at least one of the transmission channels is configured for transmission to first data transmission system characterized by a first system profile relating to a set of system parameters, and at least another of the transmission channels is configured for transmission to a second data transmission system characterized by a second system profile relating to the set of system parameters.

23. The method for routing parameter sensitive data as recited in claim 22, further comprising:
receiving input data from a plurality of reception channels, at least one of the reception channels being configured to receive from a first data receiving system characterized by a third system profile relating to the set of system parameters, and at least another of which being configured to receive from a second data receiving system characterized by a fourth system profile relating to the set of system parameters,
wherein at least one of the set of system parameters relates to physical latency;
analyzing at least a portion of the received data to make a data handling determination,
converting at least a portion of the received data into input data, the input data being compatible with an input data receiver; and
transmitting at least a portion of the input data to the input data receiver.

24. The method for routing parameter sensitive data as recited in claim 22, wherein the determining step further comprises:
receiving a data flow profile relating to characteristics of the portion of output data and being based on a set of predetermined data flow profile criteria;
receiving channel profiles for at least two of the transmission channels, at least a portion of the channel profiles relating to the set of system parameters and being based on a set of predetermined channel profile criteria; and
determining an optimal transmission channel for transmitting the portion of output data, based at least in part on an analysis of the data flow profile and the channel profiles.

25. The method for routing parameter sensitive data as recited in claim 23, wherein the data handling determination comprises data processing actions relating to at least one of data synchronization, data routing, or data de-multiplexing.
